(19) United States
(12) Patent Application Publication
(10) Pub. No.: US 2001/0021365 A1
(43) Pub. Date: Sep. 13, 2001

(54) Schemes for replenishing, retarding and reversing the depletion of ozone in polar ozone layers

(76) Inventor: Henry Howard Keith, London (GB)

Correspondence Address: Henry H. Keith, 34 Tudor Close, Belsize Avenue, London, NW3 4AG, GB

(21) Appl. No.: 09/738,506

(22) Filed: Dec. 18, 2000

(30) Foreign Application Priority Data
Mar. 8, 2000 (GB) GB0005518.6

(51) Int. Cl. B01D 53/40

(52) U.S. Cl. 423/240 R

(57) ABSTRACT

Schemes, the purpose of which is to replenish, retard and reverse and eventually stop the depletion of Ozone in the Arctic and Antarctic (depleted) Ozone layers, which filters out the harmful solar UVB radiation on its way to earth having damaging effects, and which can be achieved by replenishment of Ozone methods and retarding Ozone depletion methods together with the necessarily with these methods connected various air- or spaceborne collection/delivery vehicles such as manned aircraft, unmanned aircraft, manouverable (hot air) balloons and airships with suitable propulsion engines, or a slightly modified Space Shuttle of NASA's Space Transportation System.

Retarding Ozone depletion methods utilize suitable chemical processes, which can remove the Ozone depleting substance (ODS) molecules direcly from the Ozone layers by binding the offending molecules to other elements or substances in combination with any physical process to produce substances, which can be utilized in agriculture, industry or as pharmaceutics. pa The collection of the above-named Ozone depleting molecules from the Arctic and Antarctic (depleted) Ozone layers as well as the selection of the correct preprogrammed chemical processes is achieved automatically by computer assisted evaluations of their mass spectra and cracking patterns.

This invention relates to schemes, the purpose of which is to replenish, retard and reverse the depletion of ozone in the arctic and antarctic (depleted) ozone layers. They include not only methods to facilitate this, but also their air- or spaceborne collection/delivery vehicles as described below, by which the relevant source gases can be collected and the replenishment gases can be delivered to the ozone layers.

Apart from the normal solar ozone formation and destruction processes occurring at UV radiations of wavelengths less than 200 nm and greater than 200 to 300 nm respectively, with both processes more or less balancing each other, a continuous ozone depletion is unfortunately being maintained within the polar ozone layers by the presence of originally man-made ozone-depleting substances (ODS) with various ozone depleting potentials (ODP) such as fluorocarbons (ODP=1) and bromocarbons (ODP=3 to 10) (i.e. the CFCs and Halons), which by their excitation of the existing solar UV radiations of wavelengths greater than 260 nm within these layers release chlorine and bromine molecules respectively. It is these molecules, which as all halogens acting as catalysts break down the triatomic oxygen (i.e. ozone) to diatomic oxygen molecules additionally to the conversions of the above-mentioned normal solar ozone destruction process, thereby depleting the ozone layers from ozone.

As ozone filters out the harmful solar UVB radiation on its way to earth, which can cause skin cancer and has other damaging effects, every effort should be made to replenish, retard and eventually stop the depletion of ozone from the polar ozone layers.

Because of the above described continuous ozone depletion by ODS substances within the polar ozone layers straightforward replenishment methods of the lost ozone without any ozone depletion retarding methods would only be minimally effective. It is therefore necessary for ozone recovery to apply both below described methods.

Replenishment Methods:

The release of airborne bottled ozone within the polar ozone layers. The creation of ozone from oxygen by electrostatic corona discharges either within the used collection/delivery vehicle to be later released within the polar ozone layers or from electrodes externally to such transport within the polar ozone layers. The creation of ozone from oxygen by UV radiation of less than 200 nm wavelength (under otherwise completely light excluding conditions) within the used collection/delivery vehicle to be later released within the polar ozone layers.

Retarding Ozone Depletion Methods:

In all retarding ozone depletion methods the removal of the ozone destroying halogen or ODS molecules direcly from the ozone layers can mainly be achieved by their collection (described below) and any suitable chemical process (with or without a catalyst), which can bind the offending molecules to other elements or substances by preprogrammed single or multiple chemical reactions and which, if necessary, can be combined with any physical process such as separation, electrolysis, drying, compression or liquification to produce substances, which could be utilized in agriculture, industry or as pharmaceutics.

In order to collect the above-named ozone depleting molecules from the arctic and antarctic (depleted) ozone layers at their prevailing temperature and pressure conditions the necessarily airborne, preprogrammed and automated chemical process must be preceded by the application of suitable vacuum pumps, the necessary gas conditioning including heating accessories and by the utilization of mass spectrometers of the magnetic deflection or quadruple type.

Computer assisted evaluations of their mass spectra and cracking patterns would not only enable the proper selection of the ‘offending’ molecules by their mass number, but also their correct routing by motorised or solenoid valving to the correct preprogrammed chemical processes as well as their automatic initiation to be achieved.

The retarding ozone depletion chemical/physical processes must also be followed by automated means for transferring the process products in either gaseous, liquid or solid form to suitable temporary storage containers, which are constructed of suitable materials and which, if necessary, can withstand the applied storage pressures.

The collection of the source gases for the retarding processes and/or the delivery of the replenishment gases is achieved by the necessary collection/delivery vehicles detailed below, which must be of sufficient pay-load capacity to accomodate the for both the above described methods required technical and/or process equipment and must be capable of reaching altitudes of between 15 and 30 km above the earth in order to reach the polar ozone layer destinations.

Collection/delivery vehicles can be manned aircraft, unmanned aircraft, maneuverable (hot air) balloons and airships with suitable propulsion engines, or spacecraft.

All collection/delivery vehicles except spacecraft would take off for either the arctic or antarctic polar ozone layers from suitable and not too distant take off and landing sites probably of latitudes not lower than 60 degrees North or 40 degrees South.

A preprogrammed course for all collection/delivery vehicles except spacecraft would keep the vehicles in latitudinal orbits around either pole within the extent of the depleted ozone layers.

Except for spacecraft the location of all and especially of unmanned collection/delivery vehicles is achieved by a portable navigator or equivalent computing device, which can utilise the digital radio signals from satellites of the Global Positioning System or by an at take off correctly aligned inertial guidance system.

The applied process control and gas releasing start-up commands are accomplished either by an on-board carried computer or with a slight delay by a “mission control centre” via geostationary satellites situated anywhere on the equatorial plane within communication distances of both the vehicles and the depleted (arctic and antarctic) ozone layers.

The use of an orbiter spacecraft of NASA's Space Transportation System as a collection/delivery vehicle with only minor modifications mainly to provide additional cooling as detailed below offers certain advantages over any other method of the above described source gas collection and replenishment gas delivery by the possibility that both polar ozone layers can be passed through after a normal launch from Vandenburg Air Force Base in a due southerly direction on the same longitudinal earth orbit. After having reached its normal for most other missions designed cargo transportation orbit between 185 km (115 miles) and 400 km (250 miles) above the earth, which from now on is called the “parking orbit”, the orbiter's velocity is under the control of the for this particular mission preprogrammed Guidance, Navigation and Control (GN&C) system slighly decreased to reach the upper limit of the intended “collection/delivery altitudes” of 15 to 50 km by retroactive thrusts of selected “aft” Reaction Control System (RCS) engines. after which a further controlled descend rate between the 50 km and 15 km limits by the same RCS engines is to be accomplished.

On reaching the lower (15 km) limit of the intended “collection/delivery altitudes”, which can be accurately ascertained with the help of a laser based range finder, other forward RCS engines are activated to move the orbiter gradually into the upper 50 km altitude orbit again, which can also be accurately ascertained, so that the above described controlled descend rate between the 50 km and 15 km can start again. Provided there is enough fuel for the RCS engines left this cycle can be repeated again and again, except when an emergency situation as detailed below exists.

Additional cooling of the thermal protection system (TPS) tiles within designated areas required by the orbitor's lower working altitudes consist of gaseous nitrogen, which is derived from compressed gaseous nitrogen bottles and which after the usual pressure reduction is supplied via with such areas associated thermostaticly controlled valves to the outer skin surfaces by small diameter tubing suitably protruding through the TPS tiles. Reaching a preallocated minimum amount of RCS engine fuel, the run-out or loss of the compressed nitrogen supply as well as any sensed cooling failure of any TPS tile area constitutes one of the emergency situations, which cause the orbiter to be returned into the parking orbit for natural cooling.

1. Schemes, the purpose of which is to replenish, retard and reverse and eventually stop the depletion of Ozone in the Arctic and Antarctic (depleted) Ozone layers by means of manned aircraft as the necessary collection/delivery vehicle, by which relevant Ozone depleting substances (ODS) are collected from and replenishing Ozone is delivered to roughly the same locations of the depleted Ozone layers,
and where the Ozone depleting substances (ODS) are direcly collected from the Arctic and Antarctic (depleted) Ozone layers at their prevailing temperature and pressure conditions by the application of suitable vacuum pumps, the necessary gas conditioning including heating accessories and by the utilization of suitable mass spectrometers,
which by means of computer assisted evaluations of their mass spectra and cracking patterns not only facilitate the proper selection of the ‘offending’ molecules by their mass number, but also enable the correct setting up of the correct suitable preprogrammed single or multiple chemical reactions (with or without a catalyst), which can bind the offending ODS molecules to other elements or substances by the automatic initiation of motorised or solenoid valves in order to achieve correct process flow routes,
and where, if necessary, these chemical processes can be combined with any physical process such as separation, electrolysis, drying, compression or liquification to produce substances, which in either gaseous, liquid or solid form can be transferred by automated means to suitable temporary storage containers constructed of suitable materials and able to withstand the applied storage pressures, so that the stored products can later be utilized in agriculture, industry or as pharmaceutics,
and where the manned aircraft as the necessary collection/delivery vehicle must be capable of reaching altitudes of between 15 and 30 km above the earth in order to reach the polar ozone layer destinations with sufficient pay-load capacity to accommodate all the in the above described methods required technical and process equipment, and where the location of the manned aircraft is achieved by a portable navigator or equivalent computing device, which can utilise the digital radio signals from satellites of the Global Positioning System or by an at take off correctly aligned inertial guidance system,
and where in connection with the established aircraft location the applied process control and gas releasing start-up commands are accomplished either by means of an on-bord carried computer or with a slight delay are communicated from a “mission control centre” via geostationary satellites situated anywhere on the equatorial plane within communication distances of both the vehicles and the depleted (Arctic and Antarctic) Ozone layers.

2. As claim 1, but where the necessary collection/delivery vehicle with its above stated still applicable properties is an unmanned aircraft.

3. As claim 1, but where the necessary collection/delivery vehicle with its above stated still applicable properties is a manouverable (hot air) balloon.

4. As claim 1, but where the necessary collection/delivery vehicle with its above stated still applicable properties is an airship with suitable propulsion engines.

5. As claim 1, but where the necessary collection/delivery vehicle without its above stated inapplicable properties is a Space Shuttle (i.e. an orbiter spacecraft) of NASA's Space Transportation System, which offers certain advantages over any other method of the above described ODS collection and replenishing Ozone delivery by the possibility that both polar ozone layers can be passed through after a normal launch from Vandenburg Air Force Base in a due southerly direction on the same longitudinal earth orbit, and which after having reached its normal for most other missions designed cargo transportation or “parking” orbit with an altitude of between 185 km (115 miles) and 400 km (250 miles) above the Earth has its velocity, which is under the control of the for this particular mission preprogrammed Guidance, Navigation and Control (GN&C) system, slighly decreased to reach the upper limit of the intended “collection/delivery altitudes” of 15 to 50 km by retroactive thrusts of selected “aft” Reaction Control System (RCS) engines. after which a further controlled descend rate between the upper 50 km and lower 15 km limits, which can both be accurately ascertained with the help of a laser based range finder, by the same RCS engines is to be accomplished, and which on reaching the lower (115 km) limit is gradually thrust by other forward RCS engines into the upper 50 km altitude orbit again, so that the above described controlled descents and ascents between the upper and lower orbits can be repeated again and again,
and where furthermore due to the Space Shuttle's lower working altitudes the required additional cooling of the thermal protection system (TPS) tiles within designated areas is achieved by gaseous nitrogen, which is derived from compressed gaseous nitrogen bottles and which after the usual pressure reduction is supplied via with such areas associated thermostaticly controlled valves to the outer skin surfaces by small diameter tubing suitably protruding through the TPS tiles,
and where reaching a preallocated minimum amount of RCS engine fuel, the run-out or loss of the compressed nitrogen supply or any sensed cooling failure of any TPS tile area constitutes an emergency situation, which cause the Space Shuttle to be returned into the higher altitude parking orbit for natural cooling.
